(19) United States
(12) Patent Application Publication
(10) Pub. No.: US 2007/0250411 A1
(43) Pub. Date: Oct. 25, 2007

(54) System and method for inventory tracking and control of mission-critical military equipment and supplies

(76) Inventor: Albert L. Williams, Fayetteville, NC (US)

Correspondence Address: COATS & BENNETT, PLLC, 1400 Crescent Green, Suite 300, Cary, NC, 27518, US

(21) Appl. No.: 11/392,049

(22) Filed: Mar. 29, 2006

(51) Int. Cl. G06Q 10/00

(52) U.S. Cl. 705/28

(57) ABSTRACT

A fully integrated, secure, portable, automated inventory control and tracking system for facilities storing mission-critical military equipment and supplies includes a terminal, database, and one or more reader/scanners. Software authenticates personnel requesting or returning mission-critical military equipment or supplies based on a machine-readable identifier on each individuals' badge, performs inventory control including check out and check in of the equipment and supplies based on machine-readable identifiers on the equipment, tracks calibration and maintenance requirements for the equipment, generates reports and forms, facilitates inventories, and manages the security of the facility by tracking periodic changes in facility access controls. The entire life cycle of the equipment is managed, including its history, maintenance, calibration, modification, and repair.

### BACKGROUND

The present invention relates generally to the field of inventory control and in particular to an integrated system and method for inventory tracking and control of mission-critical military equipment and supplies.

The purpose of a military force is to engage in warfare. To this end, military forces maintain, and distribute to service personnel, the implements of warfare. These are, by design and of necessity, lethal—requiring that access to them be strictly controlled. Guns, rocket launchers, tanks, and the like must be maintained in proper working order, and immediately made available to service personnel for training and deployment as required. However, the implements and materiel of warfare must be securely stored, and their use and distribution tightly controlled, to ensure public safety.

One example of a facility for storing, distributing, and maintaining control over the distribution and use of the mission-critical military equipment and supplies is an armory. An armory maintains arms—e.g., rifles, pistols, shotguns, and the like—as well as a wide variety of other equipment, such as night vision equipment, communication radios; secure communications equipment and the like. Service personnel report to the armory to be issued equipment and supplies necessary for a mission (either a training mission or a combat mission) or for maintenance. Each individual requesting arms or other equipment must be positively identified, and his or her authority to be issued the equipment must be established and verified. Specific items of equipment must be identified and “logged out” to each individual. At the completion of the mission (or as otherwise ordered), the service personnel return the arms and equipment to the armory, where each item is individually inspected and “logged in.” Prior art armory procedures, revolving around paper records, are lengthy, inaccurate and time-consuming. For example, it is not uncommon for a squad to spend four hours or more simply checking out arms and equipment from the armory prior to the start of a mission or maintenance session.

Meticulous records of the distribution and return of mission-critical military equipment, ammunition and supplies must be maintained, as well as a wide variety of records regarding maintenance, inspection, calibration, readiness levels, statistics and the like of the arms, ammunition and various items of equipment. Furthermore, records relating to the security of the armory itself are maintained. For example, locks securing the physical storage location of the armory are periodically re-keyed, and the armory itself is periodically inspected and its records reviewed. In general, a typical armory processes a massive amount of paperwork, which is often a tedious and time-consuming process. Furthermore, the maintenance of paper records complicates the task of obtaining specific information. For example, following the complete history of a particular item, such as a rifle, including not only its inspection and maintenance history, but each individual to whom it was issued for each specific mission, would require not only searching through separate sets of paper records, but manually putting together a history using information extracted from different record sets. If the paper records are lost then the unit has no proof of what has been logged out or in to the armory.

Due to the hazardous nature of arms and the like, military forces have implemented comprehensive specifications regarding the storage, inspection, maintenance, calibration, distribution, recovery, and tracking of such equipment. Compliance with these myriad specifications is time-consuming and prone to error. No electronic system exists to assist in ensuring compliance with the multitude of specifications.

Still further, many storage facilities for mission-critical military equipment and supplies, such as an armory, must be mobile. That is, the entire armory deploys with the troops it serves to a theater of operation. The need for security and the meticulous tracking of information related to the mission-critical military equipment, ammunition and supplies is not diminished during deployment. Therefore, any record-keeping system that the facility employs must be mobile.

Inventory control systems based on computer databases and machine-readable identification tags are known in the art. For example, many libraries control their inventory of books, including check-out my customers and subsequent check-in of the books, by scanning a bar code label applied to each book. However, prior art automated inventory control systems are ill suited for tracking mission-critical military equipment and supplies, due to the heightened security requirements, myriad record-keeping and tracking requirements, and mobility requirements imposed by military specifications. For example, arms are subject not only to inventory control, but also to strict maintenance schedules. Automated maintenance tracking systems, such as for motor vehicle fleets, are known in the art. However, the development, implementation, and maintenance of separate automated systems for inventory control and for maintenance tracking is duplicative, costly, complex, and results in separate and often incompatible repositories of information.

Therefore, there exist in the art a need for a fully integrated, secure, portable, automated inventory control and tracking system specifically addressing the needs and controlling the user access of facilities storing mission-critical military equipment and supplies, such as an armory.

### SUMMARY

One or more embodiments of the present invention relate to a fully automated, electronic information software application and data base management system, specializing in arsenal equipment and weapons tracking for military or law enforcement managed environments.

In one aspect, the present invention relates to an automated method of storing and tracking mission-critical military equipment, ammunition and supplies at a secure facility, each unit of mission-critical military equipment and supplies tagged with a machine-readable tag encoding a unique identifier or serial number, each identifier stored in a database. Personnel requesting or returning mission-critical military equipment, ammunition or supplies are automatically authenticated and verified. Inventory control of mission-critical military equipment, ammunition or supplies issued to and received from authenticated personnel is automatically performed using the database. Discrepancies in counts are automatically surfaced for instant notification. Calibration and maintenance requirements for the mission-critical military equipment are automatically tracked, scheduled and surfaced when due. Reports and forms related to the mission-critical military equipment and supplies are automatically generated. The security of the facility is managed by automatically tracking periodic changes in facility access controls.

In another aspect, the present invention relates to a method of issuing mission-critical military equipment, ammunition and supplies from a secure facility, each item of mission-critical military equipment, ammunition and supplies being tagged with a unique, machine-readable identification code. Each individual requesting issuance of one or more items of mission-critical military equipment, ammunition and supplies is automatically authenticated via a badge having a machine-readable identifier. The command authority of each requesting individual to be issued each item of mission-critical military equipment, ammunition and supplies automatically verified. One or more items of mission-critical military equipment, ammunition and supplies are issued to each authenticated and verified individual and the issued equipment and supplies are automatically associated with the individual.

In yet another aspect, the present invention relates to an inventory tracking and control system for mission-critical military equipment, ammunition and supplies. The system includes a secure, portable processor and one or more readers connected to the processor, each reader operative to read a unique identification code from a badge or item of mission-critical military equipment, ammunition and supplies. The system additionally includes program code executing on the processor and operative to authenticate each individual requesting issuance of one or more items of mission-critical military equipment and supplies, to verify the command authority of each requesting individual to be issued each item of mission-critical military equipment, ammunition and supplies, and upon one or more items of mission-critical military equipment, ammunition and supplies being issued to each authenticated and verified individual, to associate the issued equipment and supplies with the individual the individual's unit of assignment.

In still another aspect, the present invention relates to a program product for execution on a portable, secure computer system, the program product comprising executable code operative to cause the computer system to authenticate and verify personnel requesting or returning mission-critical military equipment, ammunition or supplies; perform inventory control of mission-critical military equipment, ammunition or supplies issued to and received from authenticated and verified personnel using a database; track calibration and maintenance requirements for the mission-critical military equipment; generate reports and forms related to the mission-critical military equipment, ammunition and supplies; and manage the security of the facility by automatically tracking periodic changes in facility and system access controls.

### BRIEF DESCRIPTION OF DRAWINGS

FIG. 1 is a representation of an armory.

FIG. 2 is a functional module diagram of software code.

FIG. 3 is a flow diagram of a method of issuing mission-critical military equipment and supplies.

FIG. 4 is a flow diagram of a method of receiving previously issued mission-critical military equipment ammunition and supplies.

### DETAILED DESCRIPTION

The integrated, secure, portable, automated inventory control and tracking system for mission-critical military equipment and supplies is described herein with reference to an armory. However, the present invention is not limited to this application. For example, the present invention may advantageously applied to inventory control and tracking of chemical, biological, radiological, and nuclear (CBRN) agents and equipment, ammunition, secure communication equipment, set, kits, outfits or a wide variety of mission-critical military equipment, ammunition and supplies that have severe security, accountability, traceability, and mobility requirements.

According to one or more embodiments of the present invention, myriad functions of a military or law enforcement armory are integrated and automated by a secure, mobile computer system to improve efficiency, reduce paperwork, enforce security, ensure compliance with scheduled maintenance and security audits, maintain records of all transactions, provide instant statistics on equipment combat readiness and facilitate operations by generating comprehensive, detailed reports.

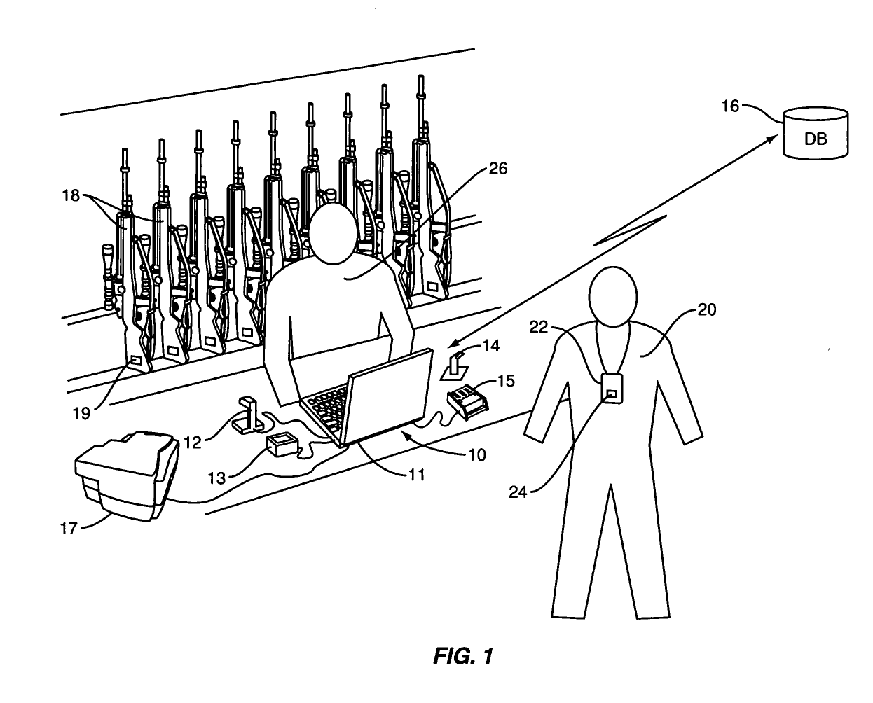

FIG. 1 depicts a representative armory deploying an automated inventory control and tracking system 10 according to one or more embodiments of the present invention. Elements of the inventive system depicted in FIG. 1 include a terminal 11; a first reader/scanner 12; a biometric scanner 13; a second reader/scanner 14; a multi-function device 15 including a touch screen display, keypad, and signature capture pad; a database 16; and a printer 17. Those of skill in the art will recognize that the database 16 may comprise software executing on the terminal 11 or other computer or server (not shown) within the system 10. The system 10 as depicted in FIG. 1 is representative only; one or more embodiments may include other peripheral devices, and may omit one or more of the peripheral elements shown.

As an introduction to the functionality and operation of the inventive automated inventory control and tracking system 10, one function of the armory—the issuance and recovery of mission-critical military equipment and supplies 18, such as rifles, to and from authorized individuals—is described.

Each unit of mission-critical military equipment, ammunition and supplies 18 is tagged with a machine-readable identifier 19. The identifiers 19 may be read by the reader/scanner 12 of the automated inventory control and tracking system 10. Each individual 20 requesting mission-critical military equipment and supplies 18 has an authorization/identification badge 22. The badge 22 could be a Command Access Card (CAC), or a smart card containing embedded processor and memory circuits. In general, it may comprise any ID badge 22 issued to military or law enforcement personnel for identification and facility access. The badge 22 bears information such as the individual's name, photograph, rank, unit, serial number, and other identifying information, as well as one or more machine-readable identifiers 24, which may be read by the reader/scanner 14 of the automated inventory control and tracking system 10.

The machine-readable identifiers 19, 24 may be optical codes such as bar codes, Radio Frequency Identification (RFID) tags, or the like. The reader/scanners 12, 14 are correspondingly optical scanners, RFID readers, or the like. In various embodiments, the machine-readable identifiers 19, 24 may of different types, and correspondingly, the reader/scanners 12, 14 are of differing types. Alternatively, the machine-readable identifiers 19, 24 and the reader/scanners 12, 14 may be of the same type. In some embodiments a single reader/scanner 12, 14 may read/scan both machine-readable identifiers 19, 24.

Armory personnel 26 verify the identity of requesting individuals 20, such as by viewing a photograph of the individual on the badge 22 and/or by reading the PKI key of the individuals CAC 22, and comparing it to a value retrieved from the database 16, associated to the individual via the machine-readable identifier 24. More accurate identification may be achieved by requiring the requesting individual 20 to enter a Personal Identification Number (PIN) or password on the keypad 15, and comparing it to a value retrieved from the database 16. Still further accuracy in identification may be achieved by reading a biometric property of the individual 20 via biometric scanner 13, and comparing a representation of the biometric property with one stored in the database 16. Biometric properties, such as fingerprints, iris scans, voiceprints, and the like, are known in the art. The photo-ID, requirement of a PIN or password, and/or biometric scan may be mixed as required to effect the requisite degree of security and identification accuracy for a given embodiment of the invention.

Once a requesting individual 20 is positively identified, his or her command authorization to receive the requested mission-critical military equipment and supplies 18 is verified. In particular, the system searches the database 16 for a record of a previously issued and currently valid order from an officer of requisite rank and authority to issue each requested item of mission-critical military equipment and supplies 18 to the requesting individual 20. This verification procedure is automatic. In general, as used herein, a procedure is performed “automatically” when the system 10 performs the procedure upon receipt of all necessary inputs, without explicit control input from a system operator, such as armory personnel 26.

When a requesting individual 20 is positively identified and his or her command authority has been automatically verified, the system 10 displays to the user (e.g., the armory personnel 26) via the terminal 11, and/or to the customer (e.g., the requesting individual 20) via the touchscreen 15, a list of specific units of mission-critical military equipment and supplies 18 authorized to be issued to the individual. The user 26 or customer 20 selects the requested items 18, and armory personnel 26 retrieve the specified mission-critical military equipment and supplies 18. The user 26 “checks out” the equipment and supplies 18 to the customer 20 by reading the machine-readable identifier 19 from each item 18 via the reader/scanner 12. The customer 20 verifies the issued equipment list as each scanned item 18 is displayed on the touch screen 15. The system 10 updates the database 16 with the status of the mission-critical military equipment and supplies 18 as having been issued to the customer 20. The database 16 associates the equipment and supplies 18 with the customer 20 via the machine-readable identifiers 19, 24. The customer 20 signs for the issued equipment via signature pad 15 or by a receipt printed from the printer 17.

Military and law enforcement armories have unique requirements that are not present in the myriad inventory control situations that may benefit from an automated check-out/check-in system such as that described above, and hence are not addressed by any prior art automated inventory control and tracking system. The equipment stored in military and law enforcement armories is subject to strict maintenance and calibration requirements; periodic inspections; and periodic inventory (e.g., daily, monthly, semi-annual, and annual).

Personnel 20 to whom mission-critical military equipment and supplies 18 are issued must be positively identified and their command authority to receive the equipment and supplies 18 must be verified. In addition, the receiving personnel 20 must have undergone training for particular units of equipment and supplies 18, and their qualifications must be current. Some equipment 18, such as certain machine guns, mortars, and the like, requires a crew (e.g., 3-man) to operate, and the entire crew must be currently qualified and have command authority before the equipment 18 may be issued.

The security of the armory facility itself must be maintained, with keys to all access points being inventoried daily, and the locks and keys changed on a regular basis (e.g., every six months). While ammunition is not normally among the equipment and supplies 18 stored in an armory, provisions exist for the temporary storage of ammunition, with strict requirements as to amount, duration, and command authority required.

Accordingly, the automated inventory control and tracking system 10 of the present invention includes far more functionality than the check-out/check-in inventory control of mission-critical military equipment, ammunition and supplies 18 described above. The software 30 creates a “virtual armory,” where the status, location, and history of every item of mission-critical military equipment, ammunition and supplies 18 is known and tracked. The software 30 tracks and manages the life cycle stream of events for every item of equipment, ammunition and supplies 18 managed by the armory. The software 30 can manage an unlimited number and variety of equipment, ammunition and supplies 18.

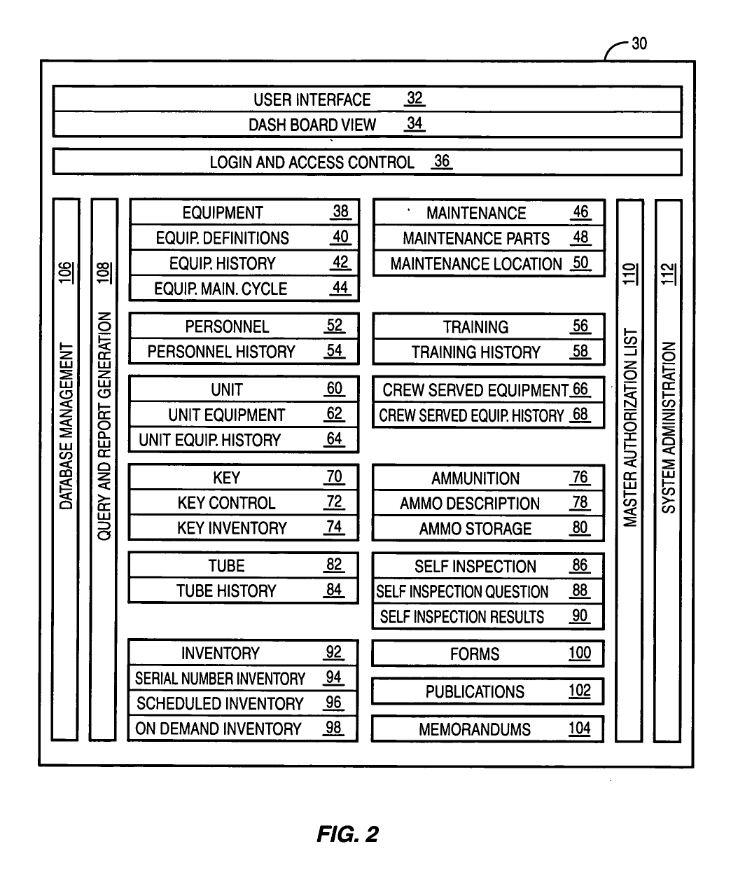

In one embodiment, the software 30 is architected using object oriented software design methodology. Accordingly, the user interface and access control, the functionality, and the support services of the software 30 are divided into a plurality of integrated modules, all of which may access the database 16. FIG. 2 is a functional block diagram of the one embodiment of the software 30 executing on the automated inventory control and tracking system 10.

The software 30 includes a user interface module 32, which includes a dashboard view functionality module 34. The user interface module 32 spans all other modules of the software 30. Beneath the user interface 32 is a login and access control module 36, which must be accessed prior to accessing any of the functional modules.

A variety of functional modules are depicted in the center of FIG. 2. These functional modules perform specific tasks, and their display in FIG. 2 does not depict or imply any particular hierarchical order. An equipment module 38 includes modules for equipment definitions 40, equipment history 42, and equipment maintenance cycle 44. A maintenance module 46 includes a maintenance parts module 48 and a maintenance location module 50. A personnel module 52 includes personnel history 54. A training module 56 includes training history 58. A unit module 60 includes unit equipment 62 and unit equipment history module 64. A crew served equipment module 66 includes a clue served equipment history module 68. A key module 70 includes key control 72 and key inventory 74 modules. An ammunition module 76 includes an ammo description module 78 and ammo storage module 80. A tube module 82 includes a tube history module 84. A self inspection module 86 includes self inspection question 88 and self inspection results 90 modules. An Inventory module 92 includes a serial number inventory module 94, a scheduled inventory module 96, and an on-demand inventory module 98. A forms module 100, publications module 102, and memorandums module 104 are additionally included among the functional modules of the software 30.

A variety of modules, depicted vertically in FIG. 2, span the functional modules, indicating that each may interact with some to all of the functional modules. These include a database management module 106, query and report generation module 108, system administration 112, and a master authorization list 110.

The equipment module 38 performs inventory tracking and control for all equipment and supplies 18 not otherwise specifically managed in another functional module. For example, the equipment module 38 performs inventory tracking and control for firearms such as rifles, sidearms, and the like, night vision equipment, body armor, communications equipment, personal navigation equipment, and the like. In general, the equipment module 38 tracks any and all mission-critical military equipment and supplies 18 stored in the armory and that may be issued to authorized individuals, with the exception of equipment especially tracked in another functional module. The equipment module tracks the location and status of equipment and supplies 18 via machine-readable identifiers 19.

The mission-critical military equipment and supplies 18 are designated in an equipment definitions module 40, which includes the equipment definitions, specifications, maintenance and calibration requirements, compatibility restrictions, and the like.

The complete history of each individual item of mission-critical military equipment and supplies 18 is tracked in an equipment history module 42. The equipment history includes a complete record of when and to whom the item 18 was issued and when it was returned; when and to whom the unit 18 was transferred for maintenance, repair, or calibration; all modifications to the item 18; and the status and condition of the item 18 at each inventory. In short, the entire history of each item of mission-critical military equipment and supplies 18 is maintained in the equipment history module 42.

The equipment maintenance cycle module 44 tracks the maintenance and calibration requirements for each individual item of mission-critical military equipment and supplies 18 in the equipment definitions module 40 on a scheduled or unscheduled maintenance basis. The maintenance cycle module 44 issues alerts for maintenance as scheduled maintenance approaches by either round counts or date and, through interaction with the query and report generation module 94, generates maintenance request and authorization forms.

The maintenance module 46 tracks maintenance requirements and activities, and displays real time maintenance status for all mission-critical military equipment and supplies 18 maintained in the armory. In particular, the maintenance module 46 automates scheduled maintenance tasks, automates unscheduled maintenance, and maintains a real-time maintenance equipment record such as a DA Form 2404 for the user. The maintenance equipment record keeps track of all deficiencies in the equipment as noted in the technical maintenance manuals. The maintenance equipment record can be reopened and edited as deficiencies occur and items removed as they are repaired. The system stores this information and maintains maintenance records (three year history) for all equipment 18, and notifies armory personnel when gauging and calibration or organizational and user maintenance are due. The maintenance module 46 notifies armory personnel when to inquire about equipment in direct support, and when equipment has been in maintenance after a set number of days.

A maintenance parts module 48 performs inventory tracking and control for spare parts, replacement parts, and the like that are necessary for performing maintenance tasks. A maintenance location module 50 tracks the physical location of each item of equipment and supplies 18 checked out for maintenance. The maintenance module may over time data mine reoccurring deficiencies and trends to assist in identifying problem areas.

A personnel module 52 maintains information on all individuals 20 authorized to receive mission-critical military equipment, ammunition and supplies 18, as well as officers having command authority over such individuals 20. The personnel module 52 includes information such as individuals' name, rank, job function, and the like. The personnel module 52 may additionally include encoded biometric properties to aid in positive identification of individuals 20. A personnel history module 54 maintains a record of personnel history, including individuals 20 transferred into and out of units served by the armory. The personnel module will identify expired accounts and personnel 20 identified on a “DO NOT ISSUE” list by officers having command authority over such individuals 20. The personnel module will automatically update the personnel database by reading the appropriate information from an readable devise such as a CAC 22.

A training module 56 tracks the training of individuals in the personnel module 52 with respect to the mission-critical of military equipment and supplies 18. For example, certain items of equipment and supplies 18 may only be issued to individuals who have completed specific training in the handling and use of the equipment and supplies 18. The training module 56 allows leaders to track weapons training information, such as qualification, hits, qualification levels, and next qualification date by team through company. The module 56 assists leaders with proper personnel assignment and allows for querying upcoming qualification requirements. A training history module 58 maintains a history of each individual's training and qualifications, and may issue alerts as qualifications need to be renewed.

A unit module 60 allows the software 30 to group and track mission-critical military equipment and supplies 18 as issued to functional military units, such as Platoon, Section, Squad, Team and Crew. A unit equipment module 62 defines the mission-critical military equipment and supplies 18 assigned to the unit, and a unit equipment history module 64 tracks the history of each unit's equipment and supplies 18, including replacements, modifications, and the like. The unit module allows for custom unit building—giving the user 26 the ability to build, edit, modify and add to the unit schema.

Certain items of mission-critical military equipment and supplies 18, such as large machine guns, can only be operated by a crew of, e.g., three individuals. Inventory tracking, unit and personnel assignment and control of such equipment and supplies 18 is performed by a crew served equipment module 66. The module 66 includes a crew served equipment history module 68 that tracks the history of the crew served equipment, personnel and training, including when and to whom it was issued, when it was returned, its maintenance history, training results and the like.

A key module 70 facilitates maintaining security of the armory facilities in accordance with military specifications by enforcing periodic inventories of keys, and periodic changes of locks and keys to all access points of the facility. The key control module 72 tracks individual keys and the personnel to whom they are assigned. The key inventory module 74 performs inventory tracking of all keys. The key control module enforces key and lock rotation requirements and provides tracking of changes in key serial numbers.

An ammunition module 76 enforces security rules relating to the temporary storage of ammunition in an armory. For example, the ammunition module 76 may require specific command authority, impose and enforce specific quantity and/or storage time limits, or the like. The ammunition module 76 maintains permanent records of ammunition storage for forensics use. An ammunition description module 78 includes information identifying each type of ammunition that may be stored, and relevant properties such as weight, environmental condition limitations, and the like. An ammunition storage module 80 tracks the physical location of the ammunition and allows for the checking in and checking out of the ammunition to authorized personnel.

A tube is the structure used to launch motor rounds. A tube module 82 separately performs inventory tracking and control for tubes. A tube history module 84 maintains records of all issuance and return of tubes, as well as all maintenance, modifications, and the like. The tube module provides for the tracking of the amount of rounds fired, rounds remaining and warns the user when the maximum rounds fired has reached an operational or safety threshold, such as the 80 percent threshold.

A self inspection module 86 periodically imposes inspection requirements on armory personnel. A self inspection question module 88 includes a list of items to be inspected, as well as additional questions to be answered during the inspection. These are displayed to armory personnel, and answers are received, through the terminal 11. A self inspection results module 90 stores the results of all self inspections, and provides reports of the inspections in various formats.

The inventory module 92 includes several methods to conduct inventories of all equipment 18 assigned to a unit by a property book officer. The inventory module 92 supports property book inventories via a serial number inventory module 94; scheduled inventories (e.g., daily, weekly, monthly, or on any desired time frame) via a scheduled inventory module 96; and spontaneous inventories via an on-demand inventory module 98; all of which are conducted in the same manner. A third party (i.e., not armory personnel 26 in the case of a monthly serial number or property book inventory), referred to herein as an inspector, will be assigned to conduct the inventory. The system 10 automatically authenticates the inspector in a procedure similar to that described above for authenticating a customer 20 (i.e., scan CAC badge 20, receive PIN or password, biometric scan, etc., and compare to values stored in database 16). Upon authenticating the inspector, the system 10 verifies that the inspector is authorized to conduct the inventory by confirming the inspector's rank and grade, and ensuring that the same inspector is not conducting more then two successive inspections. If these requirements are not met, the system 10 will not allow the inventory to proceed. Note that these requirements are representative only, and are not limiting. In general, various embodiments of the system 10 may be programmed to enforce a wide variety of specific rules and procedures, to conform to command requirements.

The authenticated and verified inspector, or the armorer 26 in the case of daily or weekly inspections, accesses the inventory module and scans all machine readable identifiers 19 on equipment and supplies 18 via reader/scanner 12. The system 10 compares the scanned identifiers 19 against the database 16. The database 16 compares the scanned inventory against anticipated inventory, accounting for equipment and supplies 18 that are properly signed out or in repair. Items that have not been scanned (i.e., missing equipment or supplies 18), are identified to the inventorying personnel by item identification, location, and slot number where the item 18 should be located in the arms room. In one embodiment, the system 10 allows three attempts to compare the data before the inventorying personnel are locked out. This precludes completion of the inventory and ensures that the unit commander is notified that a piece of equipment, supplies, or ammunition 18 may be missing. Only the commander can override the lockout.

If the discrepancy cannot be resolved the system 10 provides the mechanism to identify to whom each missing item 18 was last signed out and the duration, and the date, time, and location of the item 18 when it was last scanned. The system 10 provides a history of the life of that piece of equipment 18 for criminal forensic review by law enforcement to assist in ascertaining what happened to the lost equipment 18. The inventory module 32 also allows for inventory by type of equipment, by company, platoon, section, squad and team. It also can be inventoried by what is present, what is in maintenance, and what is signed out, among other types of inventories. When networked to a server, the system 10 can identify any piece of equipment 18 in the database 16, regardless of the unit to which it is assigned, to assist personnel 26 in locating the owner of any equipment 18 found. The inventory module 32 results in inventory reports that can be saved or printed. A history of inventories covering at least 36 months are saved.

The forms module 100 contains a list of forms included in the system 10. The forms are common use forms that are required to operate an armory on a daily bases. These pertain to the Army, Navy, Air Force, Marines, Coast Guard and Law Enforcement agencies. Both static and dynamic forms are supported. Static forms may be printed and filled out manually. Dynamic forms may be opened electronically, filled out, printed, saved, and electronically distributed (e.g., emailed). Some forms will be used as a working record of maintenance which can be updated as items are repaired. The edited forms remain in a history file for at least 36 months.

The publications module 102 includes publications, field manuals, technical bulletins, repair manuals, regulations and Standard Operating Procedures to conduct maintenance and administrative functions for Army, Navy, Air Force, Marines, Coast Guard and Law Enforcement agency armories. These manuals can be viewed and printed.

The memorandums module 104 consists of pre-formatted memorandums and forms required for reoccurring events and common armory functions. The memorandums and forms are pre formatted with the unit information, letter head, date and time, sample wording and the commanders' signature block. These forms can be viewed, edited, saved, printed, and electronically distributed. They remain in a history file for at least 36 months. The forms pertain to Army, Navy, Air Force, Marines, Coast Guard and Law Enforcement agency armories.

A plurality of system modules spans functional modules of the software 30. A database management module 106 provides an interface to the database 16 for custom inquiries and the generation of an unlimited number and type of reports. The database stores the static tables for grade, rank, branches, deficiencies, equipment descriptions, inventory detail, inventory master, maintenance reason, platoon, squad, section, team, and reason out.

A query and report generation module 108 provides a standard interface for routine queries and the generation of standardized reports. The query and report generation module 108 produces all reports, receipts, requisitions, authorizations, and other forms and reports required by applicable military and para-military rules and specifications. By way of example and without limitation, the query and report generation module 108 generates issued item reports such as team, squad, platoon, section, platoon sergeant, platoon leader, first sergeant and commanders' reports. It also generates assigned item reports for individual and crew served weapons, by team through company. The query and report generation module 108 additionally generates non-mission capable reports for all equipment. These reports include dead-lined items, where they are, how long they have been in maintenance, when they are due, and the reason, by team through company. The module 108 additionally generates numerous pre-formatted reports, selectable by drop down menu. The module 108 includes full query ability, allowing the user to custom query needed information.

A system administration module 112 provides an interface for administration tasks relating to the automated inventory control and tracking system 10 itself, such as the addition of new hardware, networking, backups, software upgrades, adding and deleting authorized system users (armory personnel), and the like.

A master authorization list 110 provides a consolidated list of standing command authority regarding the mission-critical military equipment and supplies 18. Changes to the master authorization list 110 automatically propagate to all of the functional modules, which modify their functionality accordingly. The master authorization list 110 allows for the assignment of individual and crew served weapons and equipment and prevents double assignments. It provides authorized armory personnel 26 the ability to assign by team, squad, platoon, section and company, and prevents the assignment of non-mission capable equipment. The master authorization list 110 includes the property book listing, equipment assignment, assigned personnel, and the company design display pages.

The software 30 executes on a portable, secure computer system 10 (see FIG. 1) comprising a portable user terminal 11, such as a laptop computer. Connected to the terminal 11 via wired or wireless links are one or more reader/scanners 12, 14 operative to read machine-readable identifiers 19, 24 from equipment and supplies 18 and requestor identification badges such as a CAC card 22, respectively. The system 10 may additionally include a biometric scanner 13 such as a fingerprint or iris scanner to assist in verifying requestors' identity. The user 26 interface is conducted through the use a touch screen on the terminal 11, a pointer such as a mouse, and/or a keyboard. The customer 20 interface is conducted through the use of a keypad/touch screen/signature pad 15. In various embodiments, the system 10 may additionally include one or more administrative terminals 11, peripheral devices such as paper and/or label printers 17, back-up tape drives, CD-ROM drives, peripheral bus expansion units (e.g., USB hub), and the like (not shown). The computer system 10 may include additional networked terminals 11 with reader/scanners 12. As such, the computer system 10 is scalable and may be expanded as necessary or desired for any particular armory.

The computer system 10 may be networked to other systems 10, to automate and integrate the inventory tracking and control of mission-critical military equipment and supplies 18 across two or more armories or from the lowest echelon (for example a company) incrementing up entities such as a brigade, division and army. The computer system 10 is completely portable, and may be stowed in protective cases and deployed with the armory's mission-critical military equipment and supplies 18 for training and/or operations missions. The computer system 10, its components, and software 30 are secure, complying with DOD FIPS 140-2 Security Specifications. The computer system 10 is highly reliable. For example, in one embodiment, one or more Redundant Array of Independent Disk (RAID) units are utilized for hard disk drive storage. This allows data to be easily recovered in the event of one or more disk failures.

The terminal 11 is preferably a conventional or rugidized laptop computer having touch-screen input capability. The user interface module 32 of the software 30 presents all system 10 functionality to users 26 and customers 20 via an intuitive graphical interface, and accepts inputs by the users 26 and customers 20 selecting from among options displayed on the touch-screen of the terminal 11 or touch screen 15, respectively. In particular, the dash board view module 34 presents all relevant information for normal and specialized mission-critical military equipment and supplies 18 inventory tracking and control in a compact, “dash board” view. The dash board view warns of, e.g., expired ETS (expiration of term of service or employment) and DEROS (date of rotation or date when expected to move to a new unit or department); inspection due dates; overdue maintenance items; inventory due dates; key and lock rotation dates; training expirations; ammo storage expiration; maximum rounds fired notification (80-100%); readiness rating alerts for non-mission capable systems; and full query ability. For example, the system warns armory personnel 26 and the customer 20, through the use of color coded bars and pop up screens, when an item 18 such as a weapon has reached at least 80 percent of the maximum rounds that can be fired from the equipment 18 before maintenance is due. The system 10 continues to warn on each issue or turn in occasion until it has reached 100 percent of the maximum amount of rounds that can be fired though the equipment 18.

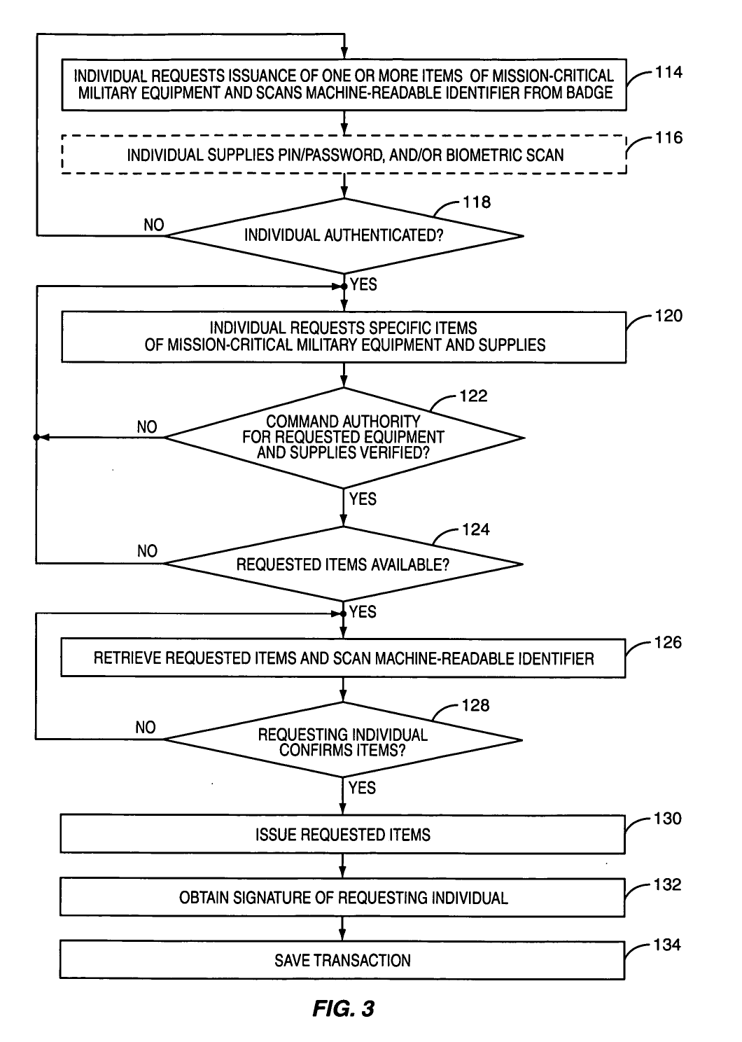

FIG. 3 depicts the process of checking out mission-critical military equipment and supplies 18 from the armory, according to one embodiment. An individual 20 requests the issuance of one or more items of equipment and supplies 18, and scans a machine-readable identifier 24 from a badge 22 (block 114) (via the reader/scanner 14). In some embodiments, the individual 20 must additionally supply a PIN or password via keypad or touch screen 15, and/or scan a biometric property into a scanner 13 (block 116). The system 10 authenticates the requesting individual 20 by comparison to personnel records in the database 16 (block 118). If the individual's identity is not authenticated, he or she may re-try a predetermined number of times (e.g., three). If the requesting individual 20 is not authenticated with in the predetermined number of re-try's, all further attempts by the individual 20 to access the system 10 are disabled until a system administrator corrects the relevant database 16 entries, and re-enables access for the individual 20.

Once the identification of the requesting individual 20 has been successfully authenticated (block 118), the individual 20 requests specific items of mission-critical military equipment and supplies 18 (block 120). The individual 20 may simply request the items from armory personnel 26, who select them from menus on the terminal 11, or the requesting individual 20 may request the selected items directly via touch screen 15. For each requested item of mission-critical military equipment and supplies 18, the system 10 verifies that the requesting individual 20 has command authority to receive the requested items 18 (block 122). Command authority refers to the entry of orders by an officer of sufficient rank authorizing the requesting individual 20 to receive the requested items 18, as well as any necessary qualifications, training requirements, and the like, which are tracked in the database 16 for each requesting individual 20.

Once the requesting individual 20 is authenticated and verified for the specific requested items of equipment and supplies 18, the system 10 queries the database 16 to determine whether the items 18 are available (block 124). If any of the requested items of equipment and supplies 18 is checked out to other individuals 20; has been removed from inventory for maintenance, calibration, or repair; has been transferred to another armory; or is otherwise unavailable, the system 10 alerts the armory personnel 26 and allows the requesting individual 20 to re-select items of mission-critical military equipment and supplies 18. If the requested items 18 are available (block 124), armory personnel 26 retrieve the requested items from inventory and scan the machine-readable identifier 19 affixed to each item 18 via reader/scanner 12 (block 126). The requesting individual 20 confirms that the equipment and supplies 18 are as requested (block 128), and if so, the items 18 are issued to the requesting individual 20 (block 130).

Armory personnel 26 obtain the signature of the requesting individual 20 (block 132) to confirm check out. This may comprise printing a receipt from the printer 17 which is signed by the requesting individual 20 and retained by armored personnel 26. Alternatively, the requesting individual's signature may be captured electronically by a signature capture pad 15, and printed. In addition, the electronic signature may be captured, placed on a form, and saved to the hard drive. The system 10 saves the transaction (block 134), associating the identifier 19 scanned from the equipment 18 with the identifier 24 scanned from the individual's badge 22, and updating the status of the equipment 18 to “checked out” by the requesting individual 20.

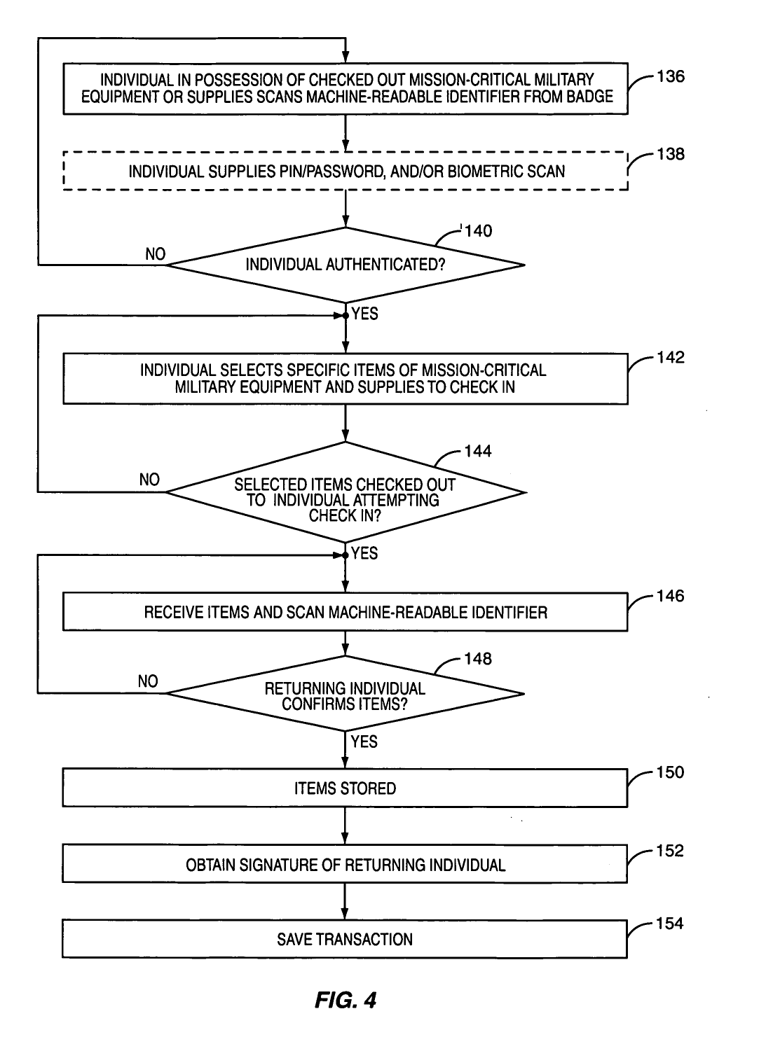

FIG. 4 depicts the process of checking in mission-critical military equipment and supplies 18 to the armory, following a training or operational mission. An individual 20 in possession of one or more items of equipment and supplies 18 scans a machine-readable identifier 24 from a badge 22 (block 136) via the reader/scanner 14. In some embodiments, the individual must additionally supply a PIN or password to the keypad 15, and/or scan a biometric property into a scanner 13 (block 138). The system 10 authenticates the individual 20 by comparing the identifier 24 to personnel records in the database 16 (block 140). If the individual's identity is not authenticated, he or she may re-try a predetermined number of times (e.g., three).

Once the identification of the requesting individual 20 has been successfully authenticated (block 140), the individual selects specific items of mission-critical military equipment and supplies 18 to check in (block 142). Either the individual 20 or armory personnel 26 may select the items 18 from a list of items 18 checked out to the individual 20 displayed on the terminal 11 or touch screen 15. For each item of equipment and supplies 18 selected to be checked in, the system 10 queries the database 16 to determine whether the item 18 is checked out to the returning individual 20 (block 144). If so, armory personnel 26 receive the items 18 from the individual 20 and scan the machine-readable identifier 19 affixed to each item 18 via reader/scanner 12 (block 146). The requesting individual 20 confirms that the equipment and supplies 18 have been returned (block 148), and if so, the items 18 are returned to storage in the armory (block 150).

Armory personnel 26 obtain the signature of the returning individual 20 (block 152) to confirm check in. This may comprise printing a receipt on the printer 17 which is signed by the requesting individual 20 and retained by armored personnel 26, or electronic signature capture via capture pad 15, which is electronically placed on a form and printed. In addition, the electronic signature may be captured, placed on a form, and saved to the hard drive. The system 10 saves the transaction (block 154), dissociates the identifier 19 scanned from the equipment 18 with the identifier 24 scanned from the individual's badge 22, updates the status of the equipment 18 to “checked in,” and updates the relevant equipment history files. Partial check in of equipment is allowed and receipts and signature readjusted and signed each time an item is turned until the individual's account is cleared.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. An automated method of storing and tracking mission-critical military equipment and supplies at a secure facility, each unit of mission-critical military equipment and supplies tagged with a machine-readable tag encoding a unique identifier, each identifier stored in a database, comprising:
automatically authenticating personnel requesting or returning mission-critical military equipment or supplies;
automatically performing inventory control of mission-critical military equipment or supplies issued to and received from authenticated personnel using the database;
automatically tracking calibration and maintenance requirements for the mission-critical military equipment;
automatically generating reports and forms related to the mission-critical military equipment and supplies; and
managing the security of the facility by automatically tracking periodic changes in facility access controls.

2. The method of claim 1 wherein authenticating personnel requesting or returning mission-critical military equipment or supplies comprises:
reading a machine-readable identification code associated with an individual from a badge presented by the individual; and
verifying the command authority of each requesting individual to be issued each item of mission-critical military equipment or supplies.

3. The method of claim 2 further comprising verifying the individual's identity by sensing a biometric property of the individual and comparing the sensed biometric property to a stored biometric property associated with the individual.

4. The method of claim 3 wherein the stored biometric property is read from the badge.

5. The method of claim 3 wherein the stored biometric property is retrieved from the database using the machine-readable identification code.

6. The method of claim 2 further comprising verifying the individual's identity by receiving from the individual a Personal Identification Number (PIN) and comparing the PIN received from the individual to a stored value of the PIN.

7. The method of claim 1 wherein the mission-critical military equipment comprises firearms.

8. The method of claim 1 wherein the mission-critical military supplies comprise ammunition.

9. The method of claim 8 further comprising maintaining a permanent record of ammunition storage for forensics use.

10. The method of claim 1 wherein the mission-critical military equipment comprises night vision equipment.

11. The method of claim 1 wherein automatically tracking calibration and maintenance requirements for the mission-critical military equipment comprises:
maintaining in the database all maintenance and calibration work performed on each unit of mission-critical military equipment;
comparing the maintenance and calibration requirements for each unit of mission-critical military equipment against the records of maintenance and calibration work performed on that unit; and
generating maintenance and calibration orders and alerts in response to the comparisons.

12. The method of claim 1 wherein managing the security of the facility by automatically tracking periodic changes in facility access controls comprises:
tracking lock and key changes at access points to the facility;
comparing the lock and key change schedules to predetermined requirements; and
generating lock and key change orders in response to the comparisons.

13. A method of issuing mission-critical military equipment and supplies from a secure facility, each item of mission-critical military equipment and supplies being tagged with a unique, machine-readable identification code, comprising:
automatically authenticating each individual requesting issuance of one or more items of mission-critical military equipment and supplies via a badge having a machine-readable identifier;
automatically verifying the command authority of each requesting individual to be issued each item of mission-critical military equipment and supplies; and
issuing one or more items of mission-critical military equipment and supplies to each authenticated and verified individual and automatically associating the issued equipment and supplies with the individual;

14. The method of claim 13 wherein authenticating each individual comprises ascertaining and verifying the identity and rank of each individual.

15. The method of claim 14 wherein ascertaining the identity of each individual comprises machine-reading a unique identification code from a badge issued to and presented by the requesting individual.

16. The method of claim 15 wherein verifying the identity of each individual comprises obtaining information from the individual, and verifying the accuracy of the information by comparison with information previously stored and associated with the individual's identification code.

17. The method of claim 16 wherein the information obtained from the individual comprises a password.

18. The method of claim 17 wherein the information obtained from the individual comprises a biometric property.

19. The method of claim 13 wherein automatically verifying the command authority of each requesting individual comprises automatically verifying a previously issued and currently valid order from an officer of requisite rank and authority to issue each requested item of mission-critical military equipment and supplies to the requesting individual.

20. The method of claim 13 wherein issuing one or more items of mission-critical military equipment and supplies to each authenticated and verified individual and automatically associating the issued equipment and supplies with the individual comprises scanning a first identification code from the a badge presented by the individual and a second identification code from each item of equipment and supplies, and associating the first and second identification codes in a database.

21. The method of claim 13 further comprising, for each item of mission-critical military equipment and supplies, automatically tracking the service, maintenance, inspection, and calibration requirements associated with the item, and automatically issuing an alert when a service, maintenance, inspection, or calibration operation is required.

22. An inventory tracking and control system for mission-critical military equipment and supplies, comprising:
a secure, portable processor;
one or more reader/scanners connected to the processor, each reader/scanner operative to read/scan a unique identification code from a badge or item of mission-critical military equipment and supplies; and
program code executing on the processor and operative to authenticate each individual requesting issuance of one or more items of mission-critical military equipment and supplies, to verify the command authority of each requesting individual to be issued each item of mission-critical military equipment and supplies, and upon one or more items of mission-critical military equipment and supplies being issued to each authenticated and verified individual, to associate the issued equipment and supplies with the individual.

23. The system of claim 22, wherein the reader/scanner comprises an optical scanner.

24. The system of claim 22, wherein the reader/scanner comprises an RFID reader.

25. The system of claim 22, wherein the system complies with the DOD DIPS 140-2 Security Specifications.

26. A program product for execution on a portable, secure computer system, the program product comprising executable code operative to cause the computer system to
authenticate personnel requesting or returning mission-critical military equipment or supplies;
perform inventory control of mission-critical military equipment or supplies issued to and received from authenticated personnel using a database;
track calibration and maintenance requirements for the mission-critical military equipment;
generate reports and forms related to the mission-critical military equipment and supplies; and
manage the security of the facility by automatically tracking periodic changes in facility access controls.

27. The program product of claim 26 wherein the executable code is further operative to cause the computer system to create and maintain a virtual armory tracking the status of every item of mission-critical military equipment and supplies in a corresponding actual armory.

28. The program product of claim 26 wherein the executable code is further operative to cause the computer system to analyze maintenance deficiencies in mission-critical military equipment and supplies and to identify maintenance trends over time based on the analysis.
